(19) United States
(12) Patent Application Publication
(10) Pub. No.: US 2021/0248162 A1
(43) Pub. Date: Aug. 12, 2021

(54) PARALLEL DATA TRANSFER FROM ONE DATABASE TO ANOTHER DATABASE

(71) Applicant: Roblox Corporation, San Mateo, CA (US)

(72) Inventors: Aswath MANOHARAN, Sunnyvale, CA (US); Jianan DUAN, Foster City, CA (US); Nikolaus SONNTAG, Foster City, CA (US)

(73) Assignee: Roblox Corporation, San Mateo, CA (US)

(21) Appl. No.: 16/789,284

(22) Filed: Feb. 12, 2020

(51) Int. Cl. G06F 16/27; G06F 16/21

(52) U.S. Cl. CPC G06F 16/275; G06F 16/214

(57) ABSTRACT

Methods, systems, and computer readable media for mass parallel transfer of data from a source database to a target database are described. Tables of the source database to be copied to the target database are identified, a number of simultaneous connections that the source database supports is determined, a plurality of machines, based on the number, are launched, and the identified tables are respectively mapped to one or more machines of the plurality of machines. Subsequently, respective mapped table data is retrieved and sent by each of the one or more machines to the target database over a network.

### TECHNICAL FIELD

This disclosure relates generally to data migration, and more particularly but not exclusively, relates to methods, systems, and computer readable media to data transfer from one database to another database.

### BACKGROUND

Generally, in big data systems, data needs to be moved from one system to another. For example, due to lack of data storage capacity in a database, the data stored in the database needs to be migrated to another database that has larger storage capacity. Also, in some instances, the database that currently stores data might not be optimal for data analytics. In such cases, the data needs to be moved to another database where the analytics can be adequately performed. Some of these databases may not reside in a same datacenter or a server, which can complicate the data transfer process.

Conventionally, to transfer the data, a single machine is employed that reads the data from a source database, and then copies the data one row at a time to a target database. However, such data transfer systems, which employ the single machine to transfer the data, are not suitable when the data volume is huge (e.g., in terabytes or other large data volume). Also, such data transfer systems are not only slow but are also not resilient, and are prone to failures (e.g., due to dependency on a single machine).

### SUMMARY

According to an aspect, a computer-implemented method comprises: identifying a plurality of tables of a source database to be copied to a target database; determining a number of simultaneous connections that the source database supports; launching a plurality of machines, wherein a total number of the plurality of machines is less than or equal to the number of simultaneous connections; mapping the plurality of tables to one or more machines of the plurality of machines; retrieving, by each of the one or more machines, respective source data from the source database, by executing a respective set of read queries on the source database, wherein the respective source data corresponds to the respective mapped one or more tables; and sending, by each of the one or more machines, the respective source data to the target database over a network.

According to another aspect, a non-transitory computer-readable medium has computer-readable instructions stored thereon, which in response to execution by a processor, cause the processor to perform or control performance of operations that comprise: identifying a plurality of tables of a source database to be copied to a target database; determining a number of simultaneous connections that the source database supports; launching a plurality of machines, wherein a total number of the plurality of machines is less than or equal to the number of simultaneous connections; mapping the plurality of tables to one or more machines of the plurality of machines; retrieving, by each of the one or more machines, respective source data from the source database, by executing a respective set of read queries on the source database, wherein the respective source data corresponds to the respective mapped one or more tables; and sending, by each of the one or more machines, the respective source data to the target database over a network.

According to still another aspect, a system includes: a non-transitory computer-readable medium with computer-executable instructions stored thereon; and a processor coupled to the computer-readable medium, and operable to execute the instructions to perform or control performance of operations that comprise: identify a plurality of tables of a source database to be copied to a target database; determine a number of simultaneous connections that the source database supports; launch a plurality of machines, wherein a total number of the plurality of machines is less than or equal to the number of simultaneous connections; map the plurality of tables to one or more machines of the plurality of machines; retrieve, by each of the one or more machines, respective source data from the source database, by executing a respective set of read queries on the source database, wherein the respective source data corresponds to the respective mapped one or more tables; and send, by each of the one or more machines, the respective source data to the target database over a network.

### BRIEF DESCRIPTION OF THE DRAWINGS

FIG. 1 is a block diagram that shows example elements of a system for data transfer, in accordance some implementations of the present disclosure.

FIG. 2 illustrates an example data transfer process using multiple machines, in accordance with some implementations of the present disclosure.

FIG. 3 illustrates example sub-processes of the data transfer process, in accordance with some implementations of the present disclosure.

FIG. 4 is a flowchart that illustrates an example method of data transfer, in accordance with some implementations of the present disclosure.

FIG. 5 is a block diagram that illustrates an example computing device, in accordance with some implementations of the present disclosure.

### DETAILED DESCRIPTION

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some embodiments”, “an embodiment”, “an example embodiment”, etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be effected in connection with other embodiments whether or not explicitly described.

The present disclosure addresses the above-described drawbacks in current data migration processes, by providing techniques that include transferring data from a source database (or other source storage device) to a target database (or other target storage device) by employing a plurality of machines. The data to be copied is identified, mapped to the machines (e.g., each machine is mapped with/to different data), and then the respective mapped data is retrieved by each of the machines and sent to the target database over a network. The transfer of data from the source database to the target database by employing the plurality of machines results in parallel mass transfer of data.

In some implementations, the plurality of machines may include a plurality of virtual machines. The data to be copied is identified, mapped to the machines (e.g., each virtual machine is mapped with/to different data), and then the respective mapped data is retrieved by each of the virtual machines and sent to the target database over a network.

In some implementations, a plurality of physical machines may be employed, instead of, or in addition to, the plurality of virtual machines, to transfer the data from the source database to the target database. For example, the data to be copied is identified, mapped to the physical machines (e.g., each physical machine is mapped with/to different data), and then the respective mapped data is retrieved by each of the physical machines and sent to the target database over a network.

The present disclosure also provides techniques that try to ensure that the source database is not overloaded by the plurality of machines simultaneously executing read queries on the source database, as techniques disclosed herein provide that the number of machines to be launched for copying the data from the source database to the target database are determined based on an available capacity (e.g., current capacity) of the source database, e.g., based on a number of simultaneous connections that the source database supports. Additionally, in accordance with the techniques disclosed herein, the data to be copied is intelligently partitioned and mapped to the plurality of machines such that the available computational resources (e.g., virtual machines or physical machines) are well utilized.

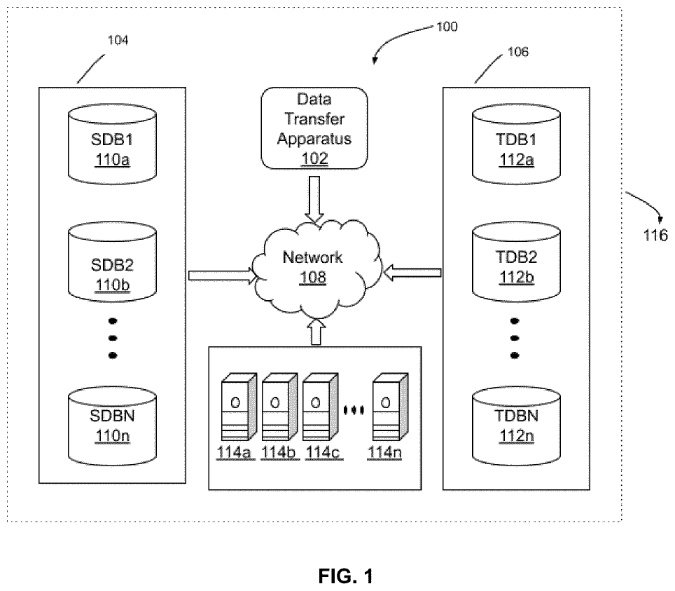

FIG. 1 is a block diagram that shows example elements of a system 100 that may be employed to transfer data, in accordance with some implementations. Specifically, system 100 may be a sub-system of an overall system architecture, wherein FIG. 1 depicts the primary example elements of the system 100 that may be involved in data transfer.

The various elements of the system 100 are shown in FIG. 1 as discrete/separate elements for purposes of illustration and explanation. According to some embodiments, it is possible to combine some of these elements into a single element or device, while in other embodiments, these elements (and/or sub-elements thereof) may be distributed across a network.

For simplicity of explanation and for illustrative purposes, the various implementations will be described herein in the context of virtual machines. In other implementations, the machines may be implemented by physical machines, or a combination of physical machines and virtual machines.

Some or all of the elements of the system 100 may be a part of or may be associated with a collaboration platform 116. The collaboration platform 116 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to provide a user with access to collaboration platform 116. The collaboration platform 116 may also include a web site (e.g., a webpage) or application back-end software that may be used to provide a user with access to content provided by collaboration platform 116. For example, users may access collaboration platform 116 using a collaboration application on client devices.

In some implementations, collaboration platform 116 may be a type of social network providing connections between users. In some implementations, collaboration platform 116 may be a gaming platform, such as an online gaming platform. For example, the gaming platform may provide single-player or multi-player games to a community of users that may access or interact with the games using client devices. In implementations, games (also referred to as “video game,” “online game,” or “virtual game” herein) may be two-dimensional (2D) games, three-dimensional (3D) games, virtual reality (VR) games, or augmented reality (AR) games, for example. In implementations, a game may be played in real-time with other user of the game.

In some implementations, the collaboration platform 116 may host one or more media items. Media items can include, but are not limited to, digital video, digital movies, digital photos, digital music, audio content, melodies, website content, social media updates, electronic books (ebooks), electronic magazines, digital newspapers, digital audio books, electronic journals, web blogs, real simple syndication (RSS) feeds, electronic comic books, software applications, etc. In implementations, a media item may be an electronic file that can be executed or loaded using software, firmware or hardware configured to present the digital media item to an entity.

The system 100 includes a data transfer apparatus 102 such as a server, engine, manager, or other hardware/and or software device having data transfer capability, a source datacenter 104, a target datacenter 106, source databases 110a, 110b, . . . 110n (hosted by the source datacenter 104), target databases 112a, 112b, . . . 112n (hosted by the target datacenter 106), and a plurality of virtual machines 114a, 114b, 114c, . . . 114n, each of which may be communicatively coupled to each other through a network 108. The network 108 may be used for wired and/or wireless communication between the data transfer apparatus 102, the source datacenter 104, the target datacenter 106, the source database(s) 110 (shown as 110a . . . 110n), the target database(s) 112 (shown as 112a . . . 112n), and the virtual machines 114 (shown as 114a . . . 114n).

In some implementations, the network 108 may include a public network (e.g., the Internet), a private network (e.g., a local area network (LAN) or wide area network (WAN)), a wired network (e.g., Ethernet network), a wireless network (e.g., an 802.11 network, a WiFi® network, or wireless LAN (WLAN)), a cellular network (e.g., a Long Term Evolution (LTE) network), routers, hubs, switches, server computers, and/or a combination thereof.

In some implementations, the data transfer apparatus 102 may be one or more computing devices (e.g., a rackmount server, a server computer, etc.). In some implementations, the data transfer apparatus 102 may be included in the collaboration platform, may be an independent system, or may be part of another system or platform. The data transfer apparatus 102 may also be implemented as a component of the source datacenter 104, the target datacenter 106, the source database(s) 110, and/or the target database(s) 112.

In some implementations, the source datacenter 104 and the target datacenter 106 may comprise one or more computing devices such as applications and databases. The computing devices may be coupled to each other in each datacenter by one or more communication links. Each of the source datacenter 104 and the target datacenter 106 may also include storage devices for storing data and as well as associated metadata. The data may be associated with a collaboration platform (e.g., a gaming platform) and may include game play data, game development data, game users' information such as user profile data, other data, etc. etc. Each of source datacenter 104 and target datacenter 106 may include one or more databases for registering and/or storing data associated with content created in the system 100 (e.g., content created by content sources in the collaboration platform).

The source datacenter 104 may host one or more source databases 110, and the target datacenter 106 may host one or more target databases 112. The source databases 110 and the target databases 112 may span multiple computing devices and may store data such as content which may include any data or software instructions (e.g., game objects, game, user information, video, images, commands, media item, etc.) which may be associated with the collaboration platform.

In some implementations, the source databases 110 and the target databases 112 may be implemented as any database such as a centralized database, a distribution database, a personal database, an end-user database, a commercial database, a NoSQL database, an operational database, a relational database, a cloud database, an object-oriented database, a graph database etc.

In some implementations, the source databases 110 and/or the target databases 112 may include relational databases that allow data to be displayed as tables with rows and column. The databases implemented as relational databases may include a collection of tables, each of which have keys associated with them, the keys are used to identify specific columns or rows of a table and to facilitate faster access to a particular table, row, or column of interest. Such relational databases may provide functionality for reading, creating, updating, deleting, and modifying data, typically by using of Structured Query Language (SQL) statements or other technique.

In some implementations, the source databases 110 and/or the target databases 112 may be implemented on a cloud as cloud-based databases. In some implementations, the source databases and/or the target databases 112 may not be hosted by any of the datacenter or file server, and may be implemented as stand-alone data storage devices.

In some implementations, the source database 110 and/or the target database 112 may be one of: an online analytical processing (OLAP) database, and an online transactional processing (OLTP) database.

In some implementations, the plurality of virtual machines 114 of the system 100 may run a on a same central processing unit (CPU), or may run on different CPUs. In some implementations, the virtual machines 114 may belong to target datacenter 106 and/or target databases 112. In other implementations, the virtual machines 114 may belong to source datacenter 104 and/or source databases 110. In some implementations, the virtual machines may be implemented in the data transfer apparatus 102 which may be hosted by the source datacenter 104 and/or the target datacenter 106, or may be implemented elsewhere in the system 100 or outside of the system 100.

In some implementations some or all of the virtual machines 114 are extract-transform-load (ETL) nodes. Such ETL nodes may extract the data from a database, transform the extracted data (e.g., applying calculations, concatenations etc.), and then load the data in the same or different database.

In accordance with the present disclosure, the data transfer apparatus 102 may perform or control performance of operation to transfer (e.g., copy or migrate) data from the source database 110 to the target database 112. Though illustrated as being hosted by different datacenters in FIG. 1, the source database 110 and the target database 112 may also be hosted by a same datacenter. In implementations, where the source database 110 and the target database 112 are hosted by distinct datacenters (as illustrated in FIG. 1), the techniques disclosed herein can be performed by any of the host datacenters.

The data transfer apparatus 102 may utilize the plurality of virtual machines 114 for the data transfer from the source database 110 to the target database 112. The process of data transfer begins with the data transfer apparatus 102 identifying source data (e.g., a plurality of tables) of the source database 110 that are to be copied to the target database 112. In some implementations, the data transfer apparatus 102 receives a request from the source database 110 or the source datacenter 104 for the data transfer. The request may identify the data that is to be copied to the target database 112. The request may also identify data (e.g., tables) that are to be incrementally copied and/or data (e.g., tables) that are to be fully copied. For example, the request may include “metadata” for each table that identifies the table to be copied and its associated attributes.

In some implementations, where the source database 110 is a relational database, the data transfer apparatus 102 may read a file list (which may be received from the source database 110, the source datacenter 104, or any other entity of system 100) that may identify the tables of the source database 110 to be copied (e.g., incrementally copied or fully copied) to the target database 112. The file list may also include metadata for the tables to be copied. For instance, the data transfer apparatus 102 may read the file list, split the lines of the file list, and map different lines to the different virtual machines.

After identifying the tables, the data transfer apparatus 102 may determine an available capacity of the source database 110. For example, the data transfer apparatus 102 may determine a number of simultaneous connections that the source database 110 can support. Such number may be based on a load capacity of the source database 110, and a current load on the source database 110. The current load on the source database may be due to users of the collaboration platform currently using the source database 110 to read and/or write data. For example, when the source database 110 is a component of the gaming platform, the number of game users (or game developers) may execute read and/or write queries on the source database 110, due to which the number of simultaneous connections that the source database 110 can support at any point in time may dynamically vary.

Based on determining the number of simultaneous connections that the source database 110 supports, the data transfer apparatus 102 may determine a number of virtual machines 114 that may be launched. The number of virtual machines 114 to be launched may be equal to or less than the number of simultaneous connections so that when the virtual machines 114 execute (e.g., simultaneously execute) their respective set of read queries on the source database 110, the source database 110 does not get overloaded. Upon determining the number, the data transfer apparatus 102 may launch the determined number of virtual machines 114.

In some implementations, each virtual machine 114 may be configured to support multiple connections simultaneously, where the multiple connections may correspond to the multiple tasks performed by the virtual machine simultaneously. In some implementations, each virtual machine 114 is configured to have a one connection per task (e.g., one connection to copy the data from the source database 110).

After launching the virtual machines, the data transfer apparatus 102 may map the plurality of tables (that are to be copied) of the source database 110 to the launched one or more virtual machines 114. In some implementations, the data transfer apparatus 102 may perform one to one mapping, where one table of the source database 110 is mapped to one of the virtual machines 114. In some implementations, the data transfer apparatus 102 may perform many to one mapping, where many tables of the source database are mapped to one of the virtual machines 114. The mapping of the tables to the virtual machines may be based on the size of data to be copied, respective priority level of the tables, and the total number of virtual machines launched by the data transfer apparatus 102.

In some implementations, the data transfer apparatus 102 may divide the number of tables to be copied into multiple data slices, each of which is mapped to each of the launched virtual machines 114. The number of tables that may be mapped to each virtual machine may depend upon the respective priority level of the table. For example, the table that has a higher transfer priority (e.g., higher priority for being copied) may be divided and assigned to multiple virtual machines for faster copying onto the target database 112. Whereas, the table that has a lower transfer priority (e.g., lower priority for being copied) may be assigned to a single virtual machine, and thus may be copied at a slower rate to the target database 112.

After launching, each of the virtual machines 114 are provided with instructions about the copy operations. The instructions may be sent to the virtual machines 114 in the form of information that identifies: the source database from which the data is to be copied, the mapped table(s) to be copied, the mode of copy, and the destination database to which the data is to be copied. For example, the virtual machine 114 may obtain such information from the data transfer apparatus 102 as metadata along with the copy instructions. For instance, the launched virtual machine 114a may receive such information as: SDB1-T1-incrl-TDB3, e.g., the source database is SDB1, the table that is mapped to the virtual machine 114a is T1, which is to be incrementally copied into the target database TDB3. Similarly, another launched virtual machine 114b may receive information as SDB2-T3-full-TDB1, e.g., the source database is SDB2, the table T3 that is mapped to the virtual machine 114b is to be fully copied onto the target database TDB 1.

Additionally, the data transfer apparatus 102 may also identify the range of rows of the mapped tables, to be copied, by each of the launched virtual machines 114. The data transfer apparatus 102 may also assign a “Select” operation to each of the launched virtual machines 114. For instance, to copy the mapped table, each of the virtual machines 114 may perform a “Select” operation to select the rows of the table (for copying) that meets the particular conditions. For instance, some of the select operations assigned to the virtual machines may have a syntax such as: Select* from SDB1-T1 where updated>LAST OFFSET, Select*from SDB1-T1 where updated>LAST AND between 0 and 1 million (range of rows), Select*from SDB1-T1 where updated>LAST AND between 1 and 2 million (range of rows), Select*from SDB1-T1 where updated>LAST AND between 9 and 10 million (range of rows) etc.

After mapping, each of the one or more virtual machines 114 may retrieve respective source data from the source database 110, by executing a respective set of read queries on the source database 110, and send the respective source data to the target database 112 over the network 108. The respective source data corresponds to (e.g., includes) respective mapped one or more tables, and the rows of the respective mapped tables that were assigned to the virtual machines for copying into the target database 112. Each of the virtual machines 114 may retrieve a particular number of records per each read query, and the particular number may be based, for example, on an available capacity of the source database 110 (e.g., the number of simultaneous connections).

In some implementations, each of the virtual machines 114 may add the respective copied source data to a queue to be written to the target database, and wherein the queue is stored in one of: a memory of a target datacenter that hosts the target database or a disk storage of the target database. In some implementations, the queue may be written to a data storage, that may be cloud-hosted, from where the copied data is eventually transferred to the target database 112. In an example, the respective source data may be written to the target database 112 by the virtual machines 114 in a flat file format (e.g., files T1, files T2 etc. corresponding to copied tables T1, T2 etc.), after which the files are eventually loaded in the target database 112 as tables.

In some implementations, the one or more virtual machines 114 are also provided with information (e.g., by the data transfer apparatus 102) about the mode of copy, e.g., whether the respective mapped tables are to be fully copied or incrementally copied. Each of the one or more virtual machines 114 may copy the tables accordingly. When the mapped table is to be fully copied, the virtual machine 114 may perform the full copy of the table from the source database 110 to the target database 112. When the mapped table is to be incrementally copied, the virtual machine 114 may execute a query on the target database 112 to obtain information about the mapped table such as “last update time,”, and a count of rows updated since last update time. Based on obtaining such information, the virtual machine 114 may execute a set of read queries on the source database to copy rows of the mapped table that have been updated or modified since last update time, and may send the copied rows over the network 108 to the target database 112.

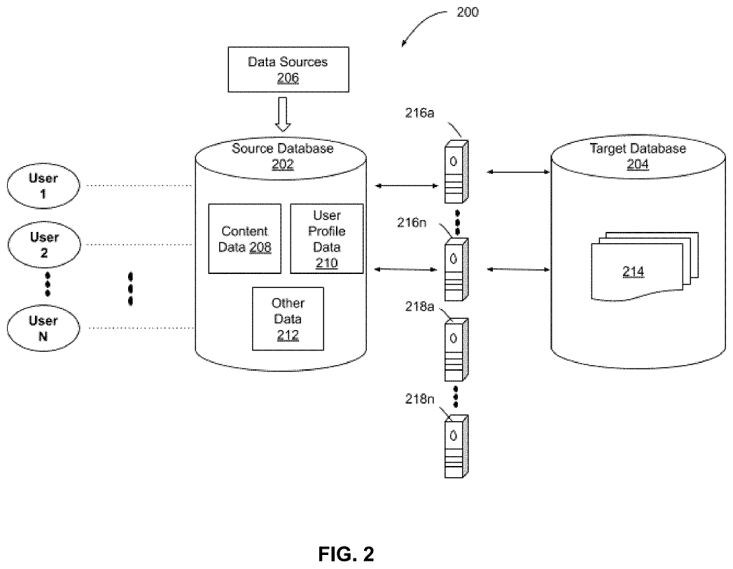

FIG. 2 illustrates an example implementation 200 of data transfer in accordance with the present disclosure. As illustrated in FIG. 2, the source database 202 (e.g., the source database 110 of FIG. 1) stores various data, from which some or all of the data may have to copied to the target database 204 (e.g., the target database 112 of FIG. 1). The source database 202 is communicatively coupled to data sources 206 from which the source database 202 may receive content data 208, user profile data 210, other data 212 etc. to be stored in the source database 202. For instance, the source database 202 may be associated with a gaming collaboration platform and may store content files received from various users (e.g., game players, game developers etc.) as content data 208. The content files may include files of models and games created by the users. These files may be, for example, in extensible markup language (XML) format, binary format, etc. The content files may also include various large media files such as textures, skyboxes, sounds, etc.

The source database 202 may also store user profile data 210 that may include, for example, profile information of each user, account information of each user, game and model information, news information, information pertaining to online forums maintained by a gaming service etc. The profile information of each user may specify, for example, games created by a user, models created by a user, public information about a user (e.g., “About Me”), recently played games, favorite games, user scores and ratings, etc. The account information may include, for example, user ID and password. The game and model information may include, for example, indexes of game and model files, indexes of corresponding game and model images, game creators, game creation dates, game popularity, user rankings of games, etc. The news information may include, for example, general information about games, information about current contests (e.g., rewards offered for users who achieve high scores for a game, etc.), etc. The forum information may include, for example, discussions about games and models, technical support forum information, etc. Some other data 212 may also be stored in the source database 202, which may include images files that include images of models and games stored on the file server or source datacenter associated with the source database 202, purchase data, transactional data etc.

In some embodiments, users may be presented with options to allow or disallow the migration of their profile information, account information, or other user-related information, or to choose the type of user-related information that may be migrated. If the user chooses to disallow or otherwise limit the migration of their data, the techniques described herein to migrate are not utilized or are otherwise limited for such user-related data. The user may be presented with further options to select whether and how their user-related data may be stored or used. For example, the user may choose to permit temporary storage of user-related data (e.g., for one or more limited time frames), and choose to disallow permanent storage of activity data.

In some implementations, the source database 202 may be a relational database, and some or all of content data 208, user profile data 210, and other data 212 may be stored thereon as a collection of tables. The tables may include some data that is static, and may include some data that is dynamically updated. Some of such tables may have to copied to the target database 204. For example, the source database 202 may have limited storage capacity, and to free up the space on the source database 202, some or all of the data may have to be migrated to another database such as the target database 204. In another example, the target database 204 is an analytics-optimized database, such as but not limited to OLAP database, and hence when analytics have to be performed on data stored in the source database 202 (which may not be optimal for analytics), the data (e.g., tables) may have to be migrated to the target database 204 for analysis.

As illustrated in FIG. 2, the data (e.g., tables) may be migrated from the source database 202 to the target database 204 by a plurality of virtual machines 216a, . . . 216n, 218a, . . . 218n. The number of virtual machines to be launched for data transfer from the source database 202 to the target database 204 may be determined based on a number of simultaneous connections that the source database 202 supports, and size of data to be copied. The number of virtual machines to be launched may be determined by a data transfer apparatus such as the data transfer apparatus 102. The number of simultaneous connections that the source database 202 may support is dynamic and may vary, for example, based on a number of users (e.g., User 1, User 2 . . . User N) that are currently accessing the source database 202. In some implementations, the data sources 206 that may be currently running queries (e.g., read query, search query, write query, etc.) on the source database 202 may also vary the number of simultaneous connections that the source database 202 can support at a current point in time.

In some implementations, the number of simultaneous connections for the source database 202 may also be anticipated (e.g., estimated) for the future based on an expected load on the source database 202 in the future. For instance, based on estimating the number of users and/or the number of data sources that may access the source database 202 at any point in the future (e.g., day, date, month, time of the year), the number of simultaneous connections (e.g., for the virtual machines 216, 218) that the source database 202 may support at that time may also be determined.

Based on determining the number of simultaneous connections that the source database 202 supports and based on size of data to be copied (e.g., number of tables, number of rows) to be copied, a number of virtual machines to be launched for data migration may be determined. For instance, based on size of data to be copied, the data transfer apparatus determines that all of the virtual machines 216a, . . . 216n, 218a, . . . 218n are to be launched

However, the available capacity of the source database 202 (e.g., the number of simultaneous connections supported by the source database 202) does not allow for all the virtual machines to be launched simultaneously. In such cases, the data transfer apparatus may determine to launch virtual machines 216a, . . . 216n, and may decide not to launch virtual machines 218a, . . . 218n. By launching the particular number of virtual machines for data transfer based on the available capacity of the source database 202, such as based on the number of simultaneous connections supported by the source database 202, the source database 202 is not overloaded, e.g., the performance of the source database 202, as well as current processes being executed on or being associated with the source database 202, are not significantly impacted

Accordingly, tables to be copied from the source database 202 are mapped to the virtual machines 216. Thereafter, each of the virtual machines 216 may retrieve respective source data (e.g., respective mapped table(s) from the source database 202) by executing a respective set of read queries on the source database 202, and send the respective source data to the target database 204, which may store the data (e.g., table(s)) 214.

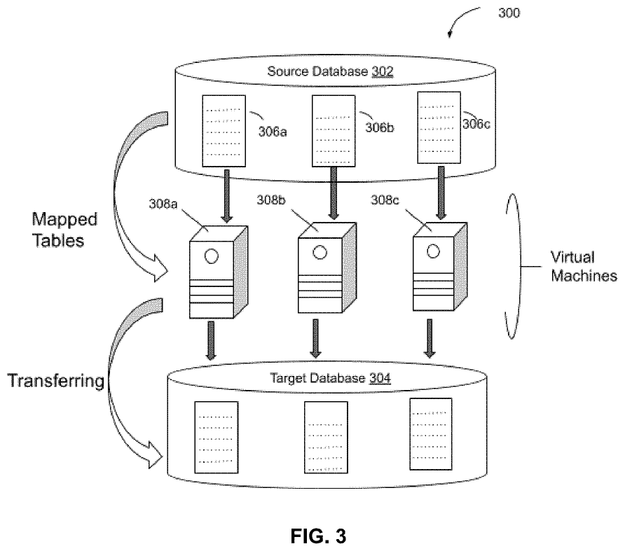

FIG. 3 illustrates an example implementation 300 of sub-processes of the data transfer process in accordance with the present disclosure. The data from the source database 302 (e.g., the source database 110 of FIG. 1) is to be copied to the target database 304 (e.g., the target database 112 of FIG. 1). The source database 302 may be a relational database, where the data is stored as a collection of tables (such as tables 306a, 306b, and 306c). The tables 306a, 306b, and 306c are to be copied to the target database 304. As illustrated in FIG. 1, the tables 306a, 306b, 306c that are to be copied from the source database 302 to the target database 304 are identified, and mapped to the virtual machines 308a, 308b, and 308c. The table 306a is mapped to the virtual machine 308a, the table 306b is mapped to the virtual machine 308b, and the table 306c is mapped to the virtual machine 308c. As can be seen in FIG. 3, each virtual machine is assigned a different table, which prevents duplication of copying, and saves computational resources. The mapping of the tables 306 to the virtual machines 308 can be performed by the data transfer apparatus (e.g., the data transfer apparatus 102 of FIG. 1).

While mapping the tables to the virtual machines, the data transfer apparatus 102 may also assign rows of the table that are to be copied by the virtual machine. For instance, for the table 306a mapped to the virtual machine 308a, the data transfer apparatus 102 may also assign rows (e.g., rows between 9 and 10 million of the table 306a) that are to be copied to the target database 304. It is to be noted that one-to-one mapping between the tables and virtual machines in FIG. 3 is for illustration purposes only. In some implementations, multiple tables may be mapped to the same virtual machine. In some implementations, same table (but different rows) may be mapped to the different virtual machines,

Each of the virtual machines 308 retrieve respective mapped tables from the source database 302 by executing a respective set of read queries on the source database 302. After retrieving the respective mapped tables, each of the virtual machines 308 may send the respective tables (forming source data) to the target database 304. In accordance with the present disclosure, each of the virtual machines 308 may perform retrieving and sending operations in parallel, thereby resulting in parallel data migration. For instance, each of the virtual machines 308 may execute their respective set of read queries on the source database 302 in parallel with each other, and may send the respective mapped source data in parallel with each other to the target database 304. In other implementations, at least some of the read queries or sending operations need not be performed in parallel, and can be performed sequentially or some other order in addition or alternative to being performed in parallel.

In some implementations, data may be sent by the virtual machines 308 in a flat file format, e.g., stored, in a flat file format, to a queue to be written to the target database 304, the queue may be stored in one of: a memory of a datacenter (or file server) that hosts the target database 304 or a disk storage of the target database 304. In some other implementations, the received data 314 may be stored by the target database 304 in the form of tables that may correspond to the copied tables of the source database 202. The format of the copied data (e.g., tables) may remain same (as the source database 202) in the target database 204.

In some implementations, the data migration from one database to another database may be performed by using Hadoop™ MapReduce™, a parallel processing framework, where some of the virtual machines 308 may be implemented as mapper nodes, and other virtual machines 308 may be implemented as reducer nodes, which may perform mapping and reducing operations respectively to transfer data from one database to another. In some implementations, each of the virtual machines 308 may be implemented as a task/container running on the mapper node and/or reducer nodes. The container may represent an allocated resource on the mapper nodes and/or the reducer node.

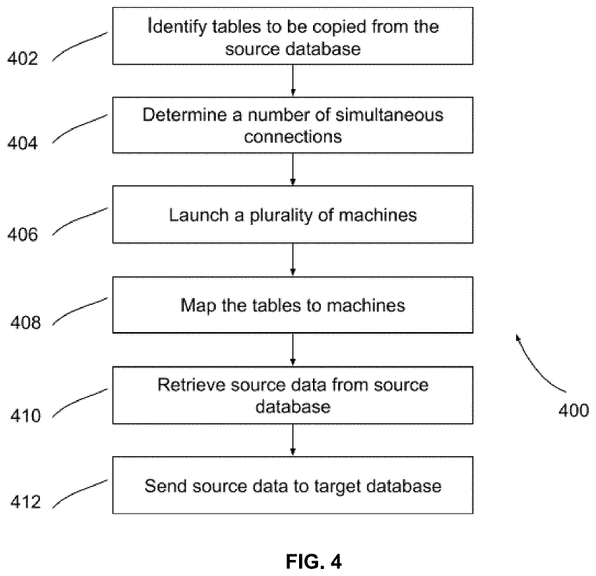

FIG. 4 is a flowchart that illustrates an example method 400 to copy data from a source database to a target database, in accordance with some implementations. The example method 400 may include one or more operations illustrated by one or more blocks, such as blocks 402 to 412. The various blocks of the method 400 and/or of any other process(es) described herein may be combined into fewer blocks, divided into additional blocks, supplemented with further blocks, and/or eliminated based upon the desired implementation.

The method 400 of FIG. 4 is explained herein with reference to the elements shown in FIGS. 1-3. In some embodiments, the operations of the method 400 may be performed in a pipelined sequential manner. In other embodiments, some operations may be performed out-of-order, in parallel, etc. For the sake of simplicity of explanation, the operations in the method 400 will be described below in the context of the data transfer apparatus 102 performing most or all of the operations. In other embodiments, some or all of the operations may be performed by the source datacenter 104, target datacenter 106, the virtual machines 114 or by some other element associated with a collaboration platform.

At a block 402 (“Identify tables to be copied from the source database”), the data transfer apparatus 102 identifies the table of the source database 110 to be copied to the target database 112. In some implementations, the data transfer apparatus 102 receives, from the source database 110 over the network 108, an information indicative of the tables to be copied. The block 402 may be followed by a block 404.

At the block 404 (“Determine a number of simultaneous connections”), the data transfer apparatus 102 determines a number of simultaneous connections that the source database 110 supports. The block 404 may be followed by a block 406.

At the block 406 (“Launch a plurality of machines”), the data transfer apparatus 102 launches a plurality of virtual machines 114, wherein a total number of the plurality of virtual machines 114 is less than or equal to the number of simultaneous connections. The block 406 may be followed by a block 408.

At the block 408 (“Map the tables to machines”), the data transfer apparatus 102 maps the plurality of tables (to be copied from the source database) to one or more virtual machines of the plurality of virtual machines 114. In some implementations, the data transfer apparatus 102 assigns a different table to each of the one or more virtual machines. In some implementations, the data transfer apparatus 102 determines a respective priority level of each of the plurality of tables, determines, based on the respective priority level, a number of virtual machines to which each table is to be mapped; and maps, based on determined number, each table to at least one virtual machine. In some implementations, to map the plurality of tables to the one or more virtual machines, the data transfer apparatus 102 assigns a range of rows of the respective mapped table, to be copied, to each virtual machine of the one of more virtual machines. The block 408 may be followed by a block 410.

At the block 410 (“Retrieve source data from source database”), each of the one or more virtual machines 114 retrieves respective source data from the source database 110, by executing a respective set of read queries on the source database 110. The respective source data corresponds to the respective mapped one or more tables. The block 410 may be followed by a block 412.

At the block 412 (“Send source data to target database”), each of the one or more virtual machines 114 sends the respective source data to the target database 112 over a network 108. In some implementations, each of the one or more virtual machines 114 adds the respective source data to a queue to be written to the target database 112, wherein the queue is stored in one of: a memory of a target datacenter 106 that hosts the target database 112 or a disk storage of the target database 112.

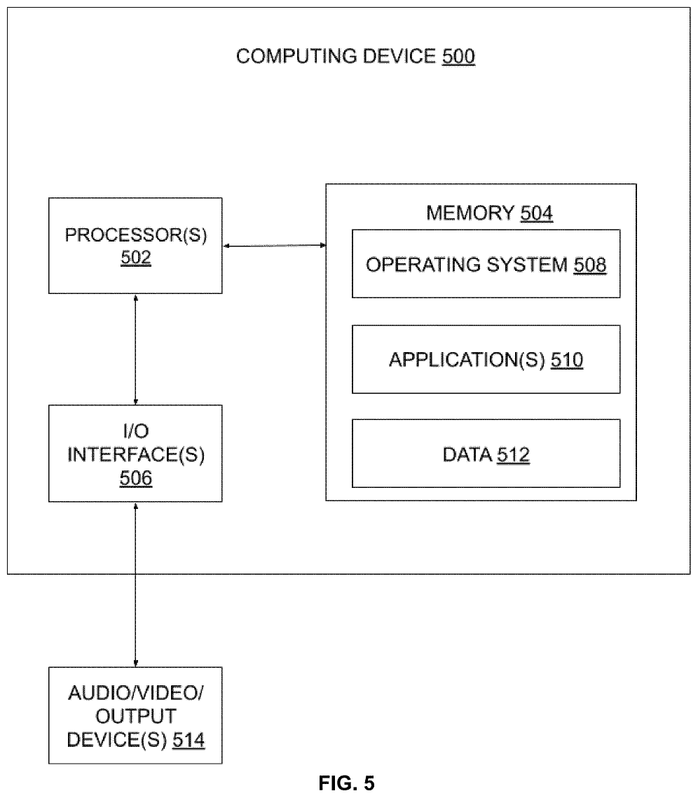

FIG. 5 is a block diagram of an example computing device 500 which may be used to implement one or more features described herein. The data transfer apparatus 102 may be provided in the form of the computing device 500 of FIG. 5. In one example, the computing device 500 may be used to perform the methods described herein to identify a plurality of tables of a source database to be copied to a target database, determine a number of simultaneous connections that the source database supports, launch a plurality of machines, wherein a total number of the plurality of machines is less than or equal to the number of simultaneous connections; map the plurality of tables to one or more machines of the plurality of machines; control (e.g., enable) each of the one or more machines to retrieve respective source data from the source database, by executing a respective set of read queries on the source database, wherein the respective source data corresponds to the respective mapped one or more tables; and control sending, by each of the one or more machines, the respective source data to the target database over a network.

The computing device 500 can be any suitable computer system, server, or other electronic or hardware device. For example, the computing device 500 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, the device 500 includes at least one processor 502, a memory 504, an input/output (I/O) interface 506, and audio/video input/output devices 514.

The processor 502 can be one or more processors and/or processing circuits to execute program code and control basic operations of the computing device 500. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

The memory 504 may be provided in the computing device 500 for access by the processor 502, and may be any suitable processor-readable storage medium, e.g., random access memory (RAM), read-only memory (ROM), electrical erasable read-only memory (EEPROM), flash memory, etc., suitable for storing instructions for execution by the processor, and located separate from processor 502 and/or integrated therewith. The memory 504 can store software executable on the computing device 500 by the processor 502, including an operating system 508, one or more applications 510 and its related data 512. In some implementations, the application 510 can include instructions that, in response to execution by the processor 502, enable the processor 502 to perform or control performance of the operations described herein with respect to transfer data from the source database to the target database.

Any of software in the memory 504 can alternatively be stored on any other suitable storage location or computer-readable medium. In addition, memory 504 (and/or other connected storage device(s)) can store instructions and data used in the features described herein. The memory 504 and any other type of storage (magnetic disk, optical disk, magnetic tape, or other tangible media) can be considered “storage” or “storage devices.”

The I/O interface 506 can provide functions to enable interfacing the computing device 500 with other systems and devices. For example, network communication devices, storage devices (e.g., databases), virtual machines, and input/output devices can communicate with the computing device 500 via an I/O interface 506. In some implementations, the I/O interface 506 can connect to interface devices including input devices (keyboard, pointing device, touchscreen, microphone, camera, scanner, etc.) and/or output devices (display device, speaker devices, printer, motor, etc.), which are collectively shown as at least one audio/video input/output device 514.

The audio/video input/output devices 514 can include an audio input device (e.g., a microphone, etc.) that can be used to receive audio messages as input, an audio output device (e.g., speakers, headphones, etc.) and/or a display device, that can be used to provide graphical and visual output such as the example layout and elements of the data transfer apparatus 102 described above.

For ease of illustration, FIG. 5 shows one block for each of processor 502, memory 504, I/O interface 506, the application 510, etc. These blocks may represent one or more processors or processing circuitries, operating systems, memories, I/O interfaces, applications, and/or software modules. In other implementations, the device 500 may not have all of the components shown and/or may have other elements including other types of elements instead of, or in addition to, those shown herein.

One or more methods described herein (e.g., the method 500) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. field-programmable gate array (FPGA), complex programmable logic device), general purpose processors, graphics processors, application specific integrated circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method, comprising:
identifying a plurality of tables of a source database to be copied to a target database;
determining a number of simultaneous connections that the source database supports;
launching a plurality of machines, wherein a total number of the plurality of machines is less than or equal to the number of simultaneous connections;
mapping the plurality of tables to one or more machines of the plurality of machines;
retrieving, by each of the one or more machines, respective source data from the source database, by executing a respective set of read queries on the source database, wherein the respective source data corresponds to the respective mapped one or more tables; and
sending, by each of the one or more machines, the respective source data to the target database over a network.

2. The method of claim 1, wherein mapping the plurality of tables to the one or more machines comprises assigning a different table to each of the one or more machines, and wherein the machines include a virtual machine, a physical machine, or combination thereof.

3. The method of claim 1, wherein sending the respective source data to the target database comprises adding the respective source data to a queue to be written to the target database, and wherein the queue is stored in one of: a memory of a target datacenter that hosts the target database, a disk storage of the target database, or a cloud-hosted data storage.

4. The method of claim 1, further comprising:
determining, based at least on the number of simultaneous connections, and a size of data to be copied, a number of machines to be launched.

5. The method of claim 1, wherein mapping the plurality of tables to the one or more machines comprises:
determining a respective priority level of each of the plurality of tables;
determining, based on the respective priority level, a number of machines to which each table is to be mapped; and
mapping, based on determined number, each table to at least one machine.

6. The method of claim 1, wherein mapping the plurality of tables to the one or more machines comprises assigning a range of rows of the respective mapped table, to be copied, to each machine of the one of more machines.

7. The method of claim 1, wherein identifying the plurality of tables comprises receiving, over the network, an information indicative of the tables to be copied.

8. A non-transitory computer-readable medium having computer-readable instructions stored thereon, which in response to execution by a processor, cause the processor to perform or control performance of operations that comprise:
identifying a plurality of tables of a source database to be copied to a target database;
determining a number of simultaneous connections that the source database supports;
launching a plurality of machines, wherein a total number of the plurality of machines is less than or equal to the number of simultaneous connections;
mapping the plurality of tables to one or more machines of the plurality of machines;
retrieving, by each of the one or more machines, respective source data from the source database, by executing a respective set of read queries on the source database, wherein the respective source data corresponds to the respective mapped one or more tables; and
sending, by each of the one or more machines, the respective source data to the target database over a network.

9. The non-transitory computer-readable medium of claim 8, wherein mapping the plurality of tables to the one or more machines comprises assigning a different table to each of the one or more machines, and wherein the machines include a virtual machine, a physical machine, or combination thereof.

10. The non-transitory computer-readable medium of claim 8, wherein sending the respective source data to the target database comprises adding the respective source data to a queue to be written to the target database, and wherein the queue is stored in one of: a memory of a target datacenter that hosts the target database, a disk storage of the target database, or a cloud-hosted data storage.

11. The non-transitory computer-readable medium of claim 8, wherein the operations further comprise:
determining, based at least on the number of simultaneous connections, and a size of data to be copied, a number of machines to be launched.

12. The non-transitory computer-readable medium of claim 8, wherein mapping the plurality of tables to the one or more machines comprises:
determining a respective priority level of each of the plurality of tables;
determining, based on the respective priority level, a number of machines to which each table is to be mapped; and
mapping, based on determined number, each table to at least one machine.

13. The non-transitory computer-readable medium of claim 8, wherein mapping the plurality of tables to the one or more machines comprises assigning a range of rows of the respective mapped table, to be copied, to each machine of the one of more machines.

14. A system, comprising:
a non-transitory computer-readable medium with computer-executable instructions stored thereon; and
a processor coupled to the computer-readable medium, and operable to execute the instructions to perform or control performance of operations that comprise:
identify a plurality of tables of a source database to be copied to a target database;
determine a number of simultaneous connections that the source database supports;
launch a plurality of machines, wherein a total number of the plurality of machines is less than or equal to the number of simultaneous connections;
map the plurality of tables to one or more machines of the plurality of machines;
retrieve, by each of the one or more machines, respective source data from the source database, by executing a respective set of read queries on the source database, wherein the respective source data corresponds to the respective mapped one or more tables; and
send, by each of the one or more machines, the respective source data to the target database over a network.

15. The system of claim 14, wherein the operation to map the plurality of tables to the one or more machines comprises at least one operation to assign a different table to each of the one or more machines, and wherein the machines include a virtual machine, a physical machine, or combination thereof

16. The system of claim 14, wherein the operation to send the respective source data to the target database comprises at least one operation to add the respective source data to a queue to be written to the target database, and wherein the queue is stored in one of: a memory of a target datacenter that hosts the target database, a disk storage of the target database, or a cloud-hosted data storage.

17. The system of claim 14, wherein the operations further comprise:
determine, based at least on the number of simultaneous connections, and a size of data to be copied, a number of machines to be launched.

18. The system of claim 14, wherein the operation to map the plurality of tables to the one or more machines comprises one or more operations that include:
determine a respective priority level of each of the plurality of tables;
determine, based on the respective priority level, a number of machines to which each table is to be mapped; and
map, based on determined number, each table to at least one machine.

19. The system of claim 14, wherein the operation to map the plurality of tables to the one or more machines comprises at least one operation to assign a range of rows of the respective mapped table, to be copied, to each machine of the one of more machines.

20. The system of claim 14, wherein the operation to identify the plurality of tables comprises an operation to obtain, over the network, an information indicative of the tables to be copied.
